(19) United States
(12) Patent Application Publication
(10) Pub. No.: US 2010/0054492 A1
(43) Pub. Date: Mar. 4, 2010

(54) Leak-Tolerant Earspeakers, Related Portable Electronic Devices and Methods of Operating the Same

(75) Inventors: William Chris Eaton, Cary, NC (US); Eric Douglas Romesburg, Chapel Hill, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/201,103

(22) Filed: Aug. 29, 2008

(51) Int. Cl. H04R 1/10

(52) U.S. Cl. 381/74

(57) ABSTRACT

Portable electronic devices are provided including a housing and first and second audio transducers positioned in the housing. The first and second audio transducers are supported by the housing and driven out of phase relative to one another to provide a leak tolerant output from the portable electronic device. Related earspeakers and methods of operating portable electronic devices are also provided.

### FIELD OF THE INVENTION

The present invention relates to communications, and, more particularly, to earspeakers for use in portable electronic devices.

### BACKGROUND OF THE INVENTION

A balanced frequency response for an earspeaker of a portable electronic device is important for intelligibility, identification and perceived quality of sound. For example, if frequencies below 600 Hz are greatly attenuated, the user of the portable electronic device may understand everything that is said by the remote party, i.e. there may be good intelligibility, but the user may not be able to tell who the remote party is by their voice, i.e., poor identification, and may perceive that the audio quality of the portable electronic device is poor. Conversely, if frequencies below 600 Hz are significantly boosted relative to higher frequencies, the user of the portable electronic device may perceive the sound as muffled, i.e. may have poor sound quality, and may not understand everything said by the remote party, i.e., poor intelligibility.

The frequency response of a single earspeaker with a substantially sealed back volume may vary greatly as the distance between the portable electronic device and the ear changes. Thus, if the earspeaker frequency response is optimized for a case where the portable electronic device is sealed to the user's ear, the user may experience a loss of identification and quality as the portable electronic device is moved away from the ear. Conversely, if the earspeaker frequency response is optimized for a case where the portable electronic device is not sealed to the ear, the user may experience a loss in intelligibility and quality as the portable electronic device is moved closer to the ear. Therefore, a conventional earspeaker with a sealed back volume may not be optimum for both.

Users of portable electronic devices may change the distance from the earspeaker of the portable electronic device and the ear for many reasons. For example, when there are environmental noises that interfere with the user hearing the remote party, the user may instinctively press the portable electronic device against his ear to attempt to seal out the external noise. After a lengthy conversation, the user's ear may get sore and, therefore, the user may instinctively hold the portable electronic device such that it is not touching the ear. When the earspeaker's sound is uncomfortably loud, the user may move the portable electronic device away from his ear until the loudness is comfortable. Many users will simply set the volume control at maximum and control the distance from the portable electronic device to the ear to compensate for different loudness levels of different remote parties and to compensate for the dynamic environmental noise experienced while traveling.

An earspeaker that achieves a more-consistent frequency response for sealed versus unsealed and various ear-portable electronic device distances may be referred to as a “leak-tolerant” earspeaker. A conventional solution for leak tolerance is to port both the front and back waves of a single transducer to the car. A path is available from the front wave to the back wave regardless of sealing or distance to the ear, which avoids distance-dependent pressure resistance.

A side view of a conventional portable electronic device 190 including a single transducer 107 on a printed circuit board (PCB) 160 is illustrated in FIG. 1. Porting both the front wave and the back wave to the ear as illustrated in FIG. 1 may reduce sensitivity by from about 6.0 to about 8.0 dB. In other words, porting the transducer 107 using two holes 137 and 142 from a front volume and a back volume, respectively, may reduce sensitivity. As portable electronic devices become thinner and smaller than previous devices, the leak-tolerant approach discussed above may not produce sufficient/competitive loudness. Thus, conventional portable electronic devices may sacrifice leak tolerance in order to maintain loudness.

### SUMMARY OF THE INVENTION

Some embodiments of the present invention provide portable electronic devices including a housing and first and second audio transducers positioned in the housing. The first and second audio transducers are supported by the housing and including porting to provide a leak tolerant output from the portable electronic device.

In further embodiments of the present invention, the first and second audio transducers may provide an earspeaker for the portable electronic device.

In still further embodiments of the present invention the first and second transducers may include first and second earspeaker transducers each having an associated single hole in the housing porting to an earpiece of the portable electronic device. In certain embodiments, the single holes porting to the earpiece of the portable electronic device may have a diameter of from about 1.0 to about 3.0 mm and/or a total area of from about 1.0 mm² to about 10.0 mm². In certain embodiments, the single holes porting to the earpiece of the portable electronic device may have a depth of from about 0.5 mm to about 1.0 mm.

In some embodiments of the present invention, the first and second audio transducers may be connected in parallel having their polarities reversed.

In further embodiments of the present invention, the first and second transducers may be 32 ohm transducers.

In still further embodiments of the present invention, the first and second transducers may be driven out of phase relative to one another to provide the leak tolerant output from the portable electronic device.

Some embodiments of the present invention provide an earspeaker for use in a portable electronic device. The earspeaker includes first and second audio transducers configured to be driven out of phase relative to one another to provide a leak tolerant output from the portable electronic device.

Further embodiments of the present invention provide portable electronic devices including a housing and an earspeaker positioned in the housing. The earspeaker includes first and second audio transducers. The housing includes at least one hole associated with the first and second transducers porting the first and second transducers to an earpiece of the portable electronic device and at least one hole remote from the first and second transducers leaking the first and second transducers to the earpiece of the portable electronic device.

In still further embodiments of the present invention, the at least one hole in the housing associated with the first and second transducers may include first and second holes in the housing. The first hole in the housing may be associated with the first transducer and may be configured to port a first front volume of the first transducer to the earpiece of the portable electronic device. The second hole in the housing may be associated with the second transducer and may be configured to port a second front volume, separate from the first front volume, of the second transducer to the earpiece of the portable electronic device.

In some embodiments of the present invention, the at least one hole in the housing associated with the first and second transducers may include a single hole in the housing that is configured to port a common front volume of the first and second transducers to the earpiece of the portable electronic device.

Further embodiments of the present invention provide methods of operating a portable electronic device including an earspeaker having first and second transducers. The method includes driving the first and second transducers out of phase from one another to provide a leak tolerant output from the portable electronic device.

### BRIEF DESCRIPTION OF THE DRAWINGS

FIG. 1 is a cross-section of a conventional portable electronic device including a single transducer.

FIG. 2 is a cross-section of a portable electronic device including an earspeaker in accordance with some embodiments of the present invention.

FIG. 3 is a block diagram of a portable electronic device in accordance with some embodiments of the present invention.

FIG. 4 is a connection diagram illustrating connection of the first and second transducers in accordance with embodiments of the present invention illustrated in FIG. 2.

FIG. 5 is a schematic block diagram illustrating a portable electronic device and a cellular communication system in accordance with some embodiments of the present invention.

FIG. 6 is a flowchart illustrating operations according to various embodiments of the present invention.

FIGS. 7 and 8 are cross-sections of a portable electronic device including an earspeaker in accordance with some embodiments of the present invention.

FIGS. 9 and 10 are block diagrams of a portable electronic device in accordance with some embodiments of the present invention.

### DETAILED DESCRIPTION OF EMBODIMENTS OF THE INVENTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

As discussed above, as portable electronic devices become smaller and thinner, the conventional leak-tolerant approach may not produce sufficient/competitive loudness. Accordingly, some embodiments of the present invention provide devices and methods for achieving leak tolerance in a small/thin portable electronic devices while maintaining sufficient loudness. In particular, some embodiments of the present invention provide an earspeaker for use in portable electronic device including two transducers driven out of phase as will be discussed further herein with respect to FIGS. 2 through 10.

As used herein, the term “portable electronic device” includes: a cellular radiotelephone with or without a multi-line display; a Personal Communications System (PCS) terminal that combines a cellular radiotelephone with data processing, facsimile and data communications capabilities; a Personal Data Assistant (PDA) that includes a radiotelephone, pager, Internet/intranet access, Web browser, organizer, calendar and/or a global positioning system (GPS) receiver; a gaming device, an audio video player, and a conventional laptop and/or palmtop portable computer that includes a radiotelephone transceiver. Any portable electronic device capable of operating in accordance with some embodiments of the present invention may be used without departing from the scope of the present invention.

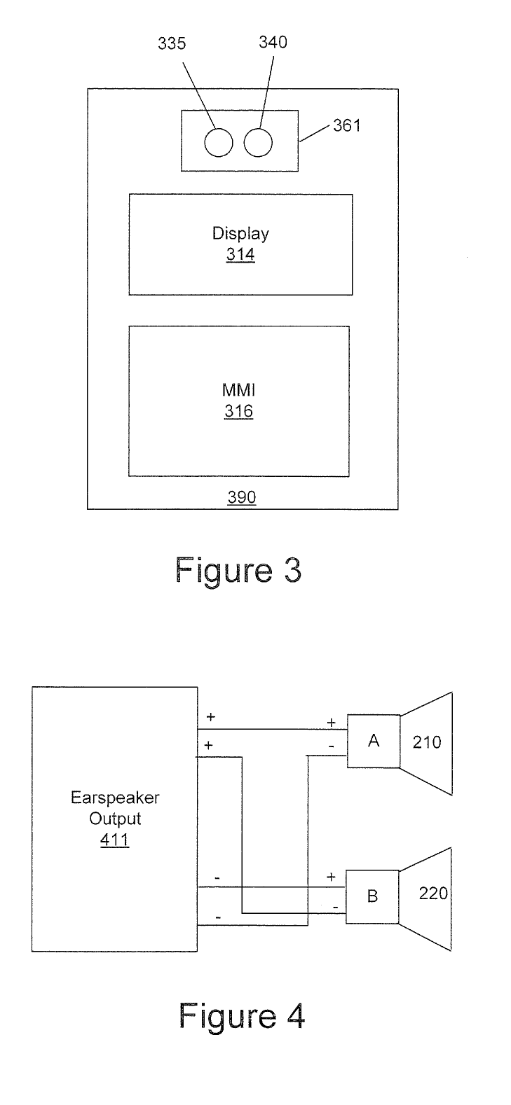

Referring first to FIG. 2, a side cross-section of a portable electronic device 290 including earspeaker 227 in accordance with some embodiments of the present invention will be discussed. As illustrated in FIG. 2, a housing 200 of a portable electronic device 290 includes an earspeaker 227 including first and second audio transducers 210, 220 in accordance with some embodiments of the present invention. The first and second audio transducers 210, 220 are positioned in the housing 200 on a printed circuit board 260 that is also positioned in the housing 200. The first and second audio transducers 210, 200 illustrated in FIG. 2 are configured as earspeaker transducers. No leak path is provided to the rear of the audio transducers 210, 220, each transducer 210, 220 has a single hole 235, 240 porting the audio transducer to an earpiece (361 of FIG. 3) of the portable electronic device 290. It will be understood that although earspeakers according to some embodiments of the present invention are illustrated as being sealed, embodiments of the present invention are not limited to this configuration. For example, a leak path (port) may be provided for one or both of the audio transducers without departing from the scope of the present invention.

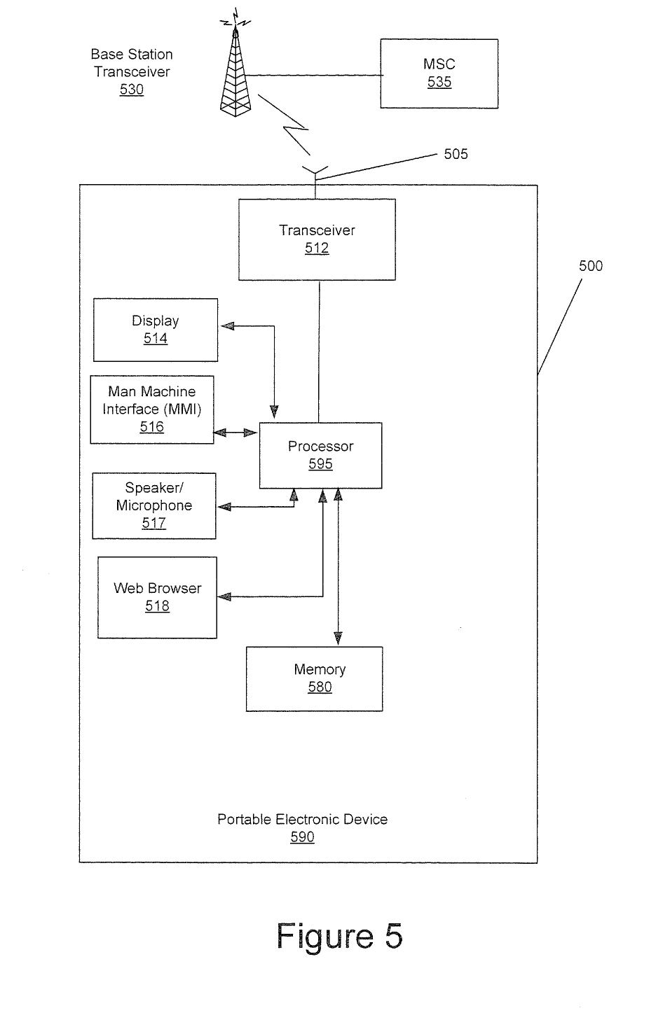

As further illustrated in FIG. 3, the port holes 335 and 340 port the first and second audio transducers 210 and 220, respectively, to the earpiece 361 of the portable electronic device 390. In some embodiments of the present invention, the holes 335 and 340 porting to the earpiece 361 of the portable electronic device 390 may have a diameter of from about 1.0 to about 3.0 mm and/or a total area of from about 1.0 mm² to about 10.0 mm². It will be understood that although the portable electronic device 390 is illustrated as having two port holes 335 and 340, embodiments of the present invention are not limited to this configuration. More than two holes may be provided in the earpiece 361 of the portable electronic device without departing from the scope of the present invention. As further illustrated in FIG. 3, the portable electronic device may further include a display 314 and a man machine interface (MMI) 316 as will be discussed further below with respect to FIG. 5.

Referring again to FIG. 2, cloths 247 and 248 are provided in the holes 235, 240, respectively, porting the first and second audio transducers 210, 220 to the earpiece 361 of the portable electronic device 290. The cloths 247 and 248 may be provided by fabrics with specific airflow resistance (acoustic impedance) in the range of from about 20 to about 200 MKS rayls to provide frequency response tuning in accordance with some embodiments of the present invention.

As further illustrated in FIG. 2, in some embodiments of the present invention the first and second transducers 210 and 220 are connected in parallel and have their polarities reversed. In particular, in some embodiments amplifiers for driving the earspeaker 227 may be differential. Such amplifiers can be adapted to the dual-transducer earspeaker in accordance with some embodiments of the present invention by connecting both transducers in parallel, with their polarities reversed. In some embodiments, the first and second transducers may be, for example, 32 ohm earspeakers, since parallel addition of two 32 ohm earspeakers would typically result in a single 16 ohm load.

A connection diagram illustrating connection of the first and second transducers 210 and 220 illustrated in FIG. 2 in parallel is illustrated in FIG. 4. As illustrated therein, the positive lead of the earspeaker output 411 can be connected to both the positive input of transducer A 210 and the negative input of transducer B 220. Similarly, the negative lead of the earspeaker output 411 can be connected to both the negative input of transducer A 210 and the positive input of earspeaker B 220.

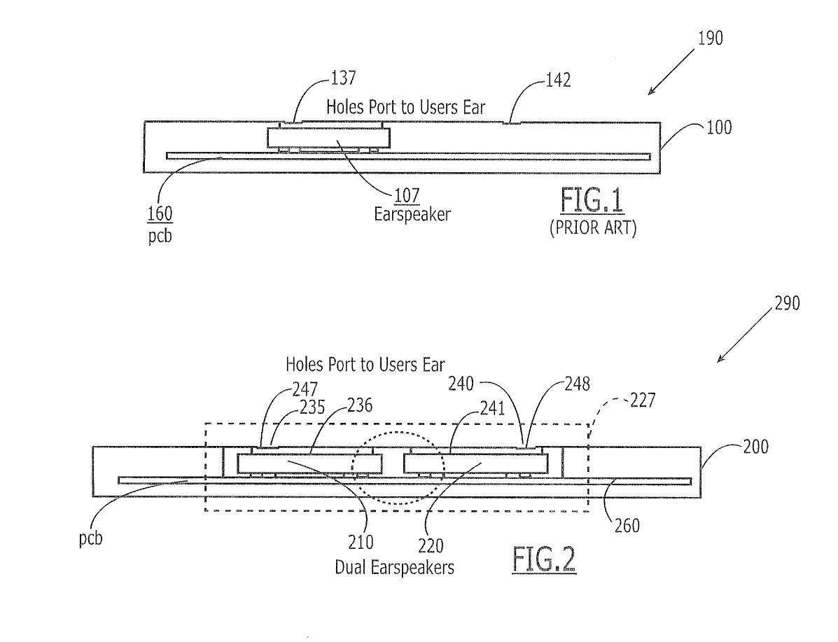

Referring now to FIGS. 2 through 4, in accordance with some embodiments of the present invention an earspeaker 227 includes first and second audio transducers 210 and 220 that are driven out of phase to create a leak-tolerant solution. In particular, the extra transducer may increase sensitivity/loudness by about 6.0 dB relative to the previous leak-tolerant solution with the same earspeaker thickness and diameter, for example, the earspeaker 107 discussed with respect to FIG. 1. Thus, according to some embodiments of the present invention, sensitivity/loudness of conventional portable electronic devices may be achieved, but may also exhibit leak tolerance. As discussed above, embodiments of the present invention discussed herein include sealed-box transducers, but embodiments of the present invention are not limited to this configuration.

As further illustrated in FIG. 2, the first and second transducers 210 and 220 are provided on a PCB 260 and have separate volumes, i.e. each transducer 210 and 220 is provided in a separate sealed volume. The first and second transducers 210 and 220 are ported to an earpiece 361 of the portable electronic device through holes 335 and 340, respectively. The front volumes 236, 241, cloths 247, 248 and ports are used to tune frequency response to comply with industry standards, for example, 3gpp template. Accordingly, although specific port sizes and cloth densities are discussed herein, embodiments of the present invention are not limited to this configuration. Different port sizes and cloth densities may be specified without departing from the scope of the present invention.

Earpiece speakers including first and second transducers 210, 220 in accordance with some embodiments of the present invention may be used in portable electronic devices like the portable electronic device 590 illustrated in FIG. 5. Referring now to FIG. 5, details with respect to portable electronic devices 590 in accordance with some embodiments of the present invention will be discussed. As illustrated in FIG. 5, the portable electronic device 590 includes a portable housing 500 and may include a display 514, a man machine interface (MMI) 516, a speaker/microphone 517, a web browser 518, a transceiver 512 and a memory 580, any of which may communicate with a processor 595. The processor 595 can be any commercially available or custom microprocessor.

As further illustrated in FIG. 5, the portable electronic device 590 communicates with a base station transceiver 530 connected to a mobile switching center (“MSC”) 535 in accordance with some embodiments of the present invention. The transceiver 512 typically includes a transmitter circuit and a receiver circuit, which respectively transmit outgoing radio frequency signals to the base station transceiver 530 and receive incoming radio frequency signals, such as voice and data signals, from the base station transceiver 530 via an antenna 505. The antenna 505 may be an embedded antenna, a retractable antenna or any antenna known to those having skill in the art without departing from the scope of the present invention. The radio frequency signals transmitted between the portable electronic device 590 and the base station transceiver 530 may include both traffic and control signals (e.g., paging signals/messages for incoming calls), which are used to establish and maintain communication with another party or destination. The processor 595 may support various functions of the portable electronic device, including functions according to some embodiments of the present invention as will be discussed further herein.

It will be understood that in some embodiments of the present invention, the transceiver 512 may be a short range transceiver. The short range transceiver may be, for example, a Bluetooth transceiver, which may allow for high transfer rates of data over relatively short distances. It will be further understood that portable electronic devices 590 according to some embodiments of the present invention may include a wireless transceiver and a short range transceiver/transmitter.

In some embodiments of the present invention, the base station transceiver 530 includes the radio transceiver(s) that defines an individual cell in a cellular network and communicates with the portable electronic device 590 and other portable electronic devices in the cell using a radio-link protocol. Although only a single base station transceiver 530 is shown, it will be understood that many base station transceivers may be connected through, for example, a mobile switching center 535 and other devices to define a wireless communications network.

Although the present invention may be embodied in communication devices or systems, such as the portable electronic device 590, the present invention is not limited to such devices and/or systems. Instead, the present invention may be embodied in any apparatus that may be configured to operate in accordance with some embodiments of the present invention.

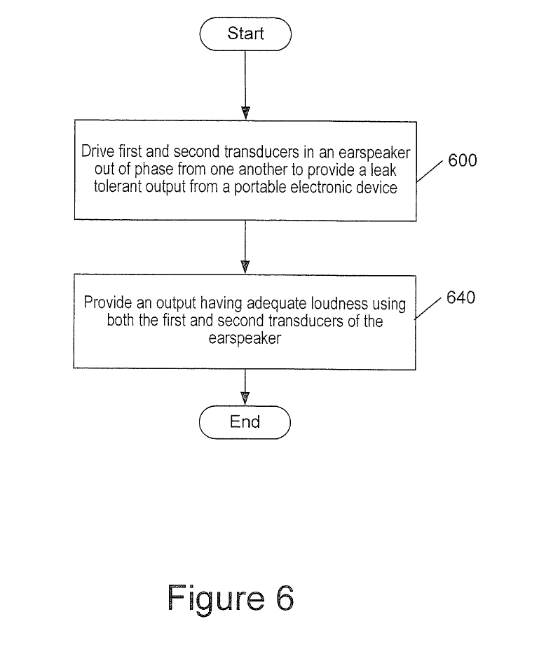

Operations in accordance with various embodiments of the present invention will now be discussed with respect to the flowchart of FIG. 6. As illustrated in FIG. 6, operations of a portable electronic device including an earspeaker including first and second transducers in accordance with some embodiments of the present invention begin at block 600 by driving the first and second transducers out of phase from one another to provide a leak tolerant output from the portable electronic device. An output having adequate loudness may be provided to the user's ear using both the first and second transducers driven out of phase (block 640).

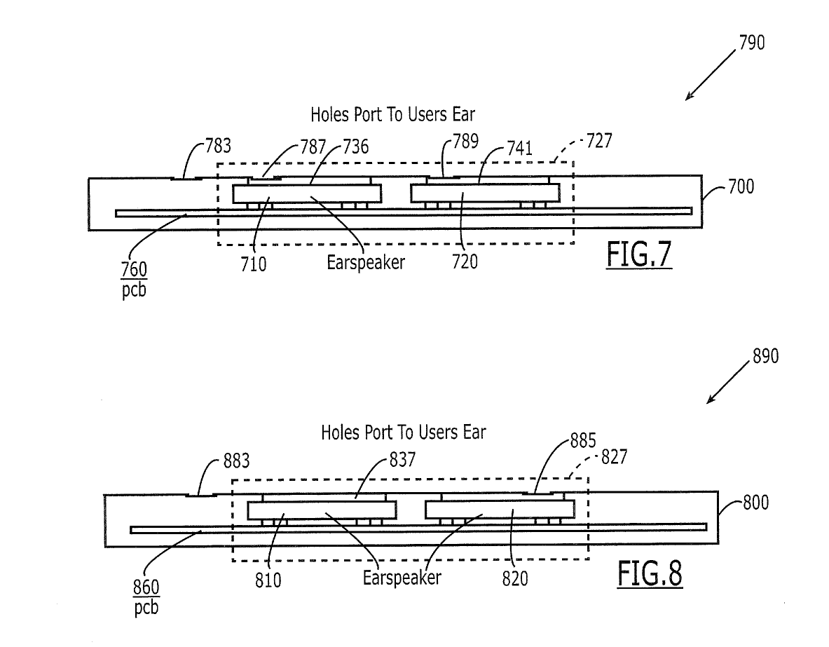

Further embodiments of the present invention will now be discussed with respect to FIGS. 7 through 10. It will be understood that like reference numerals refer to like elements throughout, accordingly details with respect to elements fully described above may not be repeated fully herein. In accordance with embodiments discussed with respect to FIGS. 7 through 10, earspeakers are provided including first and second audio transducers. The housing of the portable electronic device includes at least one hole associated with the first and second transducers porting the first and second transducers to an earpiece of the portable electronic device and at least one hole remote from the first and second transducers leaking the first and second transducers to the earpiece of the portable electronic device.

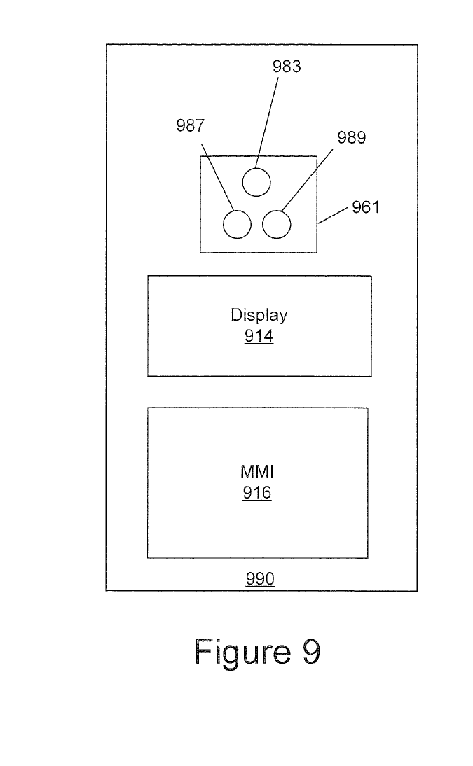

Referring first to FIG. 7, a side cross-section of a portable electronic device 790 including earspeaker 727 in accordance with some embodiments of the present invention will be discussed. As illustrated in FIG. 7, a housing 700 of a portable electronic device 790 includes an earspeaker 727 including first and second audio transducers 710, 720 in accordance with some embodiments of the present invention. The first and second audio transducers 710, 720 are positioned in the housing 700 on a printed circuit board 760 that is also positioned in the housing 700. As illustrated in FIG. 7, the first and second transducers 710, 720 have associated first and second holes 787, 789, respectively, which are configured to port the first and second transducers 710, 720 to an earpiece (961 of FIG. 9) of the portable electronic device 790. The housing 700 further includes at least one hole 783 remote from the first and second transducers that is configured to leak the first and second transducers to the earpiece (961 of FIG. 9) of the portable electronic device.

As further illustrated in FIG. 7, the first hole in the housing 787 is associated with the first transducer 710. The first hole 787 is configured to port a first front volume 736 of the first transducer 710 to the earpiece (961 of FIG. 9) of the portable electronic device. Similarly, the second hole 789 in the housing 700 is associated with the second transducer 720. The second hole 789 is configured to port a second front volume 741, which is separate from the first front volume 736, of the second transducer 720 to the earpiece (961 of FIG. 9) of the portable electronic device. A leak path is provided for the audio transducers 710, 720 through the hole 783 remote from the first and second transducers 710, 720.

As further illustrated in FIG. 9, the port holes 987 and 989 port the first and second audio transducers 710 and 720, respectively, to the earpiece 961 of the portable electronic device 990. In some embodiments of the present invention, the holes 987 and 989 porting to the earpiece 961 of the portable electronic device 1090 may have a diameter of from about 1.0 to about 3.0 mm and/or a total area of from about 1.0 mm² to about 10.0 mm². As further illustrated in FIG. 9, the portable electronic device 990 includes a leak hole 983 that is remote from the first and second transducers 710, 720 and is configured to leak the first and second transducers 710, 720 to the earpiece 961 of the portable electronic device. The portable electronic device may further include a display 914 and a man machine interface (MMI) 916 as is discussed above with respect to FIG. 5.

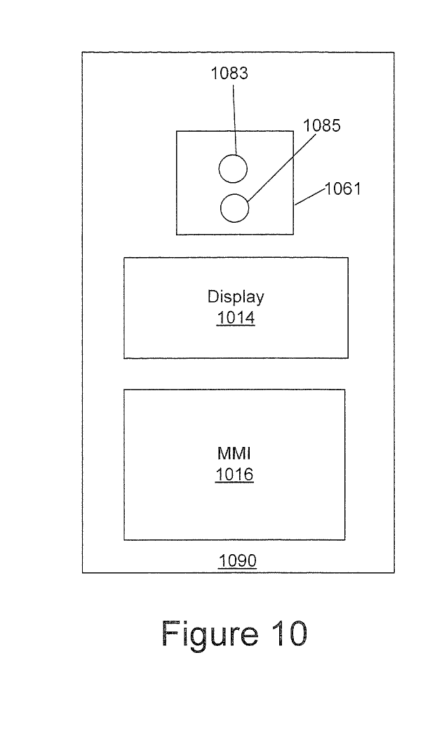

Referring now to FIG. 8, a side cross-section of a portable electronic device 890 including earspeaker 827 in accordance with some embodiments of the present invention will be discussed. As illustrated in FIG. 8, a housing 800 of a portable electronic device 890 includes an earspeaker 827 including first and second audio transducers 810, 820 in accordance with some embodiments of the present invention. The first and second audio transducers 810, 820 are positioned in the housing 800 on a printed circuit board 860 that is also positioned in the housing 800. As illustrated in FIG. 8, the first and second transducers 810, 820 have a single hole 885, which is configured to port the first and second transducers 810, 820 to an earpiece (1061 of FIG. 10) of the portable electronic device 1090. The housing 800 further includes at least one hole 883 remote from the first and second transducers that is configured to leak the first and second transducers to the earpiece (1061 of FIG. 10) of the portable electronic device.

As further illustrated in FIG. 8, the singe hole 885 is associated with in the first and second transducers 810, 820. The single hole 885 is configured to port a common front volume 837 of the first and second transducers 810, 820 to the earpiece (1061 of FIG. 10) of the portable electronic device. A leak path is provided for the audio transducers 810, 820 through the hole 883 remote from the first and second transducers 810, 820.

As further illustrated in FIG. 10, the port hole 1085 ports the first and second audio transducers 810, 820 to the earpiece 1061 of the portable electronic device 1090. In some embodiments of the present invention, the hole 1085 porting to the earpiece 1061 of the portable electronic device 1090 may have a diameter of from about 1.0 to about 3.0 mm and/or a total area of from about 1.0 mm² to about 10.0 mm². As further illustrated in FIG. 10, the portable electronic device 1090 includes a leak hole 1083 that is remote from the first and second transducers 810, 820 and is configured to leak the first and second transducers 810, 820 to the earpiece 1061 of the portable electronic device. The portable electronic device may further include a display 1014 and a man machine interface (MMI) 1016 as is discussed above with respect to FIG. 5.

As briefly discussed above with respect to FIGS. 2 through 10, earspeakers including two transducers may improve sound quality over a range of conditions and may make longer calls more practical. Embodiments of the present invention may be valuable to operators because longer calls may increase the number of minutes of usage and provide an improved proposition compared to competitor operators not having this technology. Use of portable electronic devices including earspeakers in accordance with some embodiments of the present invention may lead to increased customer satisfaction and sales, and may allow the portable electronic device to more easily pass frequency-response limits by operators using different simulated ear fixture parameters.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A portable electronic device comprising:
a housing; and
first and second audio transducers positioned in the housing, the first and second audio transducers being supported by the housing with porting to provide a leak tolerant output from the portable electronic device.

2. The portable electronic device of device of claim 1, wherein the first and second audio transducers provide an earspeaker for the portable electronic device.

3. The portable electronic device of claim 1, wherein the first and second transducers comprise first and second earspeaker transducers each having an associated single hole in the housing of the portable electronic device porting to an earpiece of the portable electronic device.

4. The portable electronic device of claim 3, wherein the single holes porting to the earpiece of the portable electronic device have a diameter of from about 1.0 to about 3.0 mm and/or a total area of from about 1.0 mm² to about 10.0 mm².

5. The portable electronic device of claim 3, wherein the single holes porting to the earpiece of the portable electronic device have a depth of from about 0.5 mm to about 1.0 mm.

6. The portable electronic device of claim 1, wherein the first and second audio transducers are connected in parallel having their polarities reversed.

7. The portable electronic device of claim 1, wherein the first and second transducers comprise 32 ohm transducers.

8. The portable electronic device of claim 1, wherein the first and second transducers are driven out of phase relative to one another to provide the leak tolerant output from the portable electronic device.

9. A method of operating the portable electronic device of claim 1.

10. An earspeaker for use in a portable electronic device, comprising first and second audio transducers configured to be driven out of phase relative to one another to provide a leak tolerant output from the portable electronic device.

11. The earspeaker of claim 10, wherein the first and second transducers comprise first and second earspeaker transducers each having a single hole porting to an earpiece of the portable electronic device.

12. The earspeaker of claim 11, wherein the single holes porting to the earpiece of the portable electronic device have a diameter of from about 1.0 to about 3.0 mm and/or a total area of from about 1.0 mm² to about 10.0 mm².

13. The earspeaker of claim 11, wherein the single holes porting to the earpiece of the portable electronic device have a depth of from about 0.5 mm to about 1.0 mm.

14. The earspeaker claim 11, wherein the first and second audio transducers are connected in parallel having their polarities reversed.

15. The earspeaker of claim 10, wherein the first and second transducers comprise 32 ohm transducers.

16. A method of operating the portable electronic device of claim 9.

17. A portable electronic device comprising:
a housing; and
an earspeaker positioned in the housing and including first and second audio transducers, wherein the housing includes at least one hole associated with the first and second transducers porting the first and second transducers to an earpiece of the portable electronic device and at least one hole remote from the first and second transducers leaking the first and second transducers to the earpiece of the portable electronic device.

18. The portable electronic device of claim 17, wherein the at least one hole in the housing associated with the first and second transducers comprises:
a first hole in the housing associated with the first transducer and configured to port a first front volume of the first transducer to the earpiece of the portable electronic device; and
a second hole in the housing associated with the second transducer and configured to port a second front volume, separate from the first front volume, of the second transducer to the earpiece of the portable electronic device.

19. The portable electronic device of claim 17, wherein the at least one hole in the housing associated with the first and second transducers comprises a single hole in the housing that is configured to port a common front volume of the first and second transducers to the earpiece of the portable electronic device.
